(19) United States
(12) Patent Application Publication
(10) Pub. No.: US 2006/0282585 A1
(43) Pub. Date: Dec. 14, 2006

(54) METHOD AND SYSTEM FOR IDENTIFYING PERIPHERAL COMPONENT INTERCONNECT DEVICE INFORMATION

(76) Inventors: Yong-Xing You, Shenzhen (CN); Feng-Long He, Shenzhen (CN); Zheng-Quan Peng, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,650

(22) Filed: Apr. 17, 2006

(30) Foreign Application Priority Data
Jun. 10, 2005 (CN) 200510035280.0

(51) Int. Cl. G06F 13/00

(52) U.S. Cl. 710/104

(57) ABSTRACT

A method for identifying Peripheral Component Interconnect (PCI) device information can identify information on all PCI devices coupled to a PCI bus. The method includes the steps: (a) initializing an address parameter and an address offset to a predetermined first number; (b) writing a first address value to a configuration port; (c) reading data from a data port based on the address value; (d) determining whether there is a corresponding PCI device coupled to the PCI bus based on the data; (e) adding a predetermined second number to the address parameter if there is no corresponding PCI device coupled to the PCI bus, so as to allocate an address for a next PCI device; (f) determining whether all the PCI devices have been searched; and (g) repeating step (b) to step (f) till all the PCI devices have been searched. A related system is also disclosed.

### FIELD OF THE INVENTION

The present invention relates to systems and methods for identifying device information of a computer, and more particularly to a method and system for identifying Peripheral Component Interconnect device information of a computer.

### DESCRIPTION OF RELATED ART

PCI (Peripheral Component Interconnect) is a local bus standard developed by Intel Corporation. Most modern PCs include a PCI bus in addition to a general ISA expansion bus. A PCI bus may be a 32-bit bus or a 64-bit bus, and it may run at clock speeds of 33 or 66 MHz. Although developed by Intel, PCI is not tied to any particular family of microprocessors, and may be used with various CPUs. Accordingly, PCI products cover a wide range of devices that interact with the PCI bus standard; these may include PCI video cards, PCI drivers, USB PCI cards, PCI simple communication controllers, and so on.

Each PCI device has a 256-byte memory space called “configuration space” that is divided into a predefined header region (64 bytes), and a device dependent region (192 bytes). There are two modes to access the configuration space of the PCI device: direct address access or BIOS (Basic Input/Output System) call access. The prior mode is achieved by writing an address value, which includes a bus number, a device number, a function number, and a series of register numbers to a configuration port, then performs an I/O read-from or a write-to a data port to operate a designated register. The later is accomplished by applying a BIOS interruption method.

Programmers develop a good many types of computer software for detecting PCI devices. For example, China App. No. 0310406.2 named “method for detecting a PCI bus” and published on Jul. 28, 2004 discloses a method for detecting information about a PCI bus of a computer. The method applies a PCI test card to access I/O and memory space of the PCI bus image, comprising the steps of: inserting a PCI test card into a PCI slot; allocating access parameters for the PCI test card according to its configuration information; writing the access parameters to a configuration space of the PCI test card; ascertaining a port mapping style of the PCI test card according to the configuration space; writing data to a 32-bit; and computing a conclusion according to the test result.

However, the above method is a hardware-based method to detect PCI bus information by a PCI test card inserted in a PCI slot. What is needed, therefore, is a system and method for detecting PCI device information with higher independency.

### SUMMARY OF INVENTION

A system for identifying PCI device information in accordance with a preferred embodiment includes: a PCI device information identifying module, a PCI bus, and a plurality of PCI devices coupled to the PCI bus. The PCI device information identifying module includes: a PCI device address configuration sub-module, a PCI device searching sub-module and a PCI device information capturing sub-module. The PCI device address configuration sub-module is used for allocating an address for each PCI device on the PCI bus; the PCI device searching sub-module is used for searching for a corresponding PCI device coupled to the PCI bus based on the address; the PCI device information capturing sub-module is used for capturing information on all the PCI devices.

Another preferred embodiment provides a method for identifying PCI device information by utilizing the above system. The method can identify information on all PCI devices coupled to a PCI bus, this includes the steps of: (a) initializing an address parameter and an address offset to a predetermined first number; (b) writing a first address value to a configuration port; (c) reading data from a data port based on the address value; (d) determining whether there is a corresponding PCI device coupled to the PCI bus based on the data; (e) adding a predetermined second number to the address parameter if there is no corresponding PCI device coupled to the PCI bus so as to allocate an address for a next PCI device; (f) determining whether all the PCI devices have been searched; and (g) repeating step (b) to step (f) until all the PCI devices have been searched.

Other advantages and novel features of the embodiments will be drawn from the following detailed description with reference to the attached drawings, in that:

### BRIEF DESCRIPTION OF DRAWINGS

FIG. 1 is a schematic diagram of hardware configuration of a system for identifying PCI device information according to a preferred embodiment;

FIG. 2 is a flowchart of a preferred method for identifying PCI device information by utilizing the system of FIG. 1; and

FIG. 3 is a detailed flowchart of the preferred method for identifying PCI device information in FIG. 2.

### DETAILED DESCRIPTION

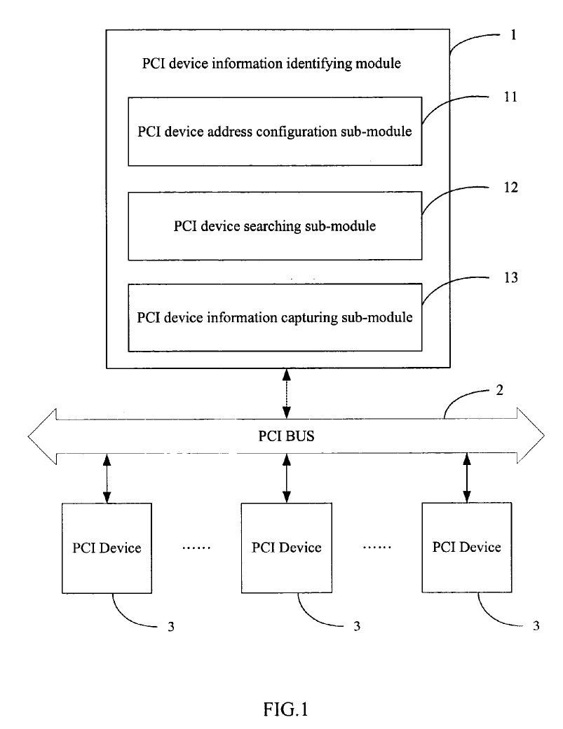

FIG. 1 is a schematic diagram of hardware configuration of a system for identifying PCI device information (hereinafter, “the system”) according to a preferred embodiment. The system includes: a PCI device information identifying module 1, a PCI bus 2, and a plurality of PCI devices 3 that are coupled to the PCI bus 2 included in a computer (not shown). The PCI device information identifying module 1 that runs in an Operation System (OS) of the computer is used for allocating an address for each PCI device 3 on the PCI bus 2, searching for a corresponding PCI device 3 coupled to the PCI bus 2 according to the address, and capturing information on all the PCI devices 3. Information on each PCI device 3 may include a vendor identification, a device identification, a revision identification, device resources, configuration space, and a device status.

The PCI device information identifying module 1 includes a PCI device address configuration sub-module 11, a PCI device searching sub-module 12, and a PCI device information capturing sub-module 13. The PCI device address configuration sub-module 11 is used for allocating an address for each PCI device 3 on the PCI bus 2. The PCI device searching sub-module 12 is used for searching for a corresponding PCI device 3 coupled to the PCI bus 2 based on the address. The PCI device information capturing sub-module 13 is used for capturing information on all the PCI devices 3.

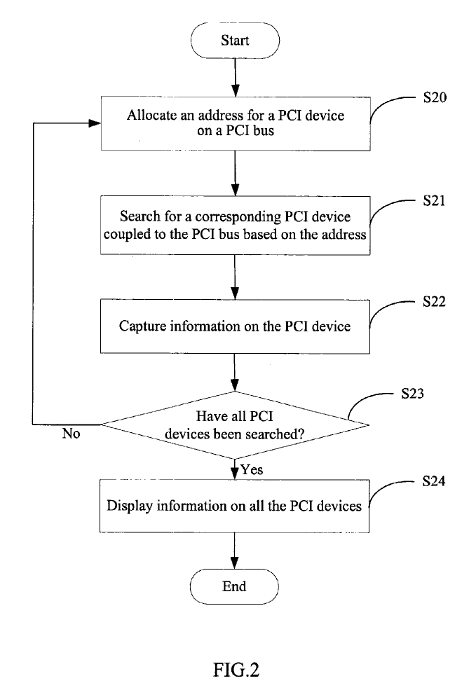

FIG. 2 is a flowchart of a preferred method for identifying PCI device information by utilizing the system of FIG. 1. In step S20, the PCI device address configuration sub-module 11 allocates an address for a PCI device 3 on the PCI bus 2. In step S21, the PCI device searching sub-module 12 searches for a corresponding PCI device 3 coupled to the PCI bus 2 based on the address. In step S22, the PCI device information capturing sub-module 13 captures information on the PCI device 3. In step S23, the PCI device address configuration sub-module 11 determines whether all the PCI devices 3 coupled to the PCI bus 2 have been searched. If any PCI device 3 has not been searched, the procedure goes to step S20 described above, in order to allocate an address for a next PCI device 3. Otherwise, if all the PCI devices 3 have been searched, in step S24, the PCI device information capturing sub-module 13 displays information on all the PCI devices 3 through an output device such as a monitor (not shown).

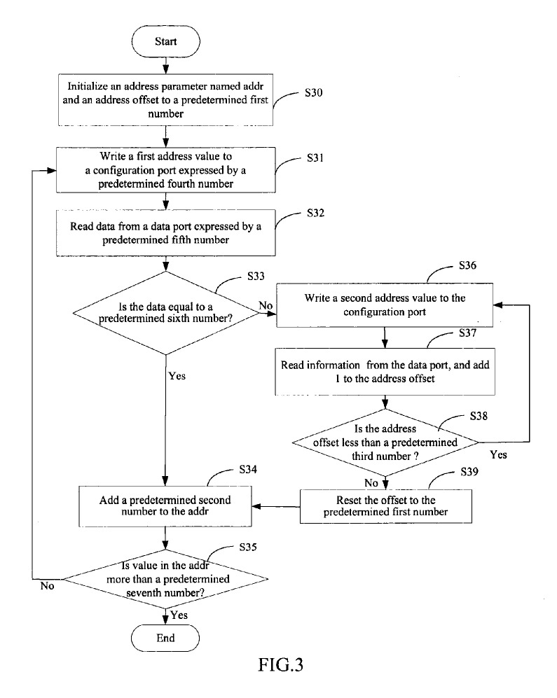

FIG. 3 is a detailed flowchart of the preferred method for identifying PCI device information in FIG. 2. In step S30, the PCI device address configuration sub-module 11 initializes an address parameter named addr and an address offset (hereinafter, “the offset”) to a predetermined first number, such as a hexadecimal number “0×00”. In step S31, the PCI device address configuration sub-module 11 writes a first address value, such as a sum of a predetermined second hexadecimal number “0×80000000” and the value in the addr, to a configuration port that is expressed by a predetermined fourth number, such as a hexadecimal number “0×CF8”. Wherein, the hexadecimal number “0×80000000” is in 32 bits, such that: values in bits 16-23 represent a bus number, values in bits 11-15 represent a device number, values in bits 8-10 represent a function number, and the remaining bits are reserved. In step S32, the PCI device address configuration sub-module 11 reads data from a data port that is expressed by a predetermined fifth number, such as a hexadecimal number “0×CFC”, based on the address value. In step S33, the PCI device searching sub-module 12 determines whether the data is equal to a predetermined sixth number, such as a hexadecimal number “0×FFFFFFF”, determining whether there is a corresponding PCI device 3 coupled to the PCI bus 2. If the data is equal to the number “0×FFFFFFF”, that means there is no corresponding PCI device 3 coupled to the PCI bus 2, in step S34, the PCI device address configuration sub-module 11 adds the predetermined second number “0×80000000” to the value in the addr, so as to allocate an address for a next PCI device 3. In step S35, the PCI device address configuration sub-module 11 determines whether the value stored in the addr is more than a predetermined seventh number, such as a hexadecimal number “0×80FFFF00”, concluding whether all the PCI devices have been searched. If the value in the addr is less than or equal to “0×80FFFF00”, the procedure goes to step S31 described above. Otherwise, if the value in the addr is more than “0×80FFFF00,” the procedure ends.

If in step S33 the data value isn't equal to “0×FFFFFFF”, that means there is a corresponding PCI device 3 coupled to the PCI bus 2, in step S36, the PCI device address configuration sub-module 11 writes a second address value “0×80000000+addr+offset” to the configuration port “0×CF8.” Then in step S37, the PCI device information capturing sub-module 13 captures information on the PCI device 3 from the data port “0×CFC”, and the PCI device address configuration sub-module 11 adds 1 to the offset. In step S38, the PCI device address configuration sub-module 11 determines whether the offset is less than a predetermined third number, such as a decimal number 64, determining whether all information of the PCI device 3 has been captured. If the offset is less than 64, the procedure goes to step S36. Otherwise, the procedure goes to step S39 to reset the offset to the determined first number, such as “0×00”, then the procedure goes to step S34 described above.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for identifying Peripheral Component Interconnect (PCI) device information, the system comprising a PCI device information identifying module, a PCI bus and a plurality of PCI devices coupled to the PCI bus, the PCI device information identifying module comprising:
a PCI device address configuration sub-module for allocating an address for each PCI device on the PCI bus;
a PCI device searching sub-module for searching for a corresponding PCI device coupled to the PCI bus based on the address; and
a PCI device information capturing sub-module for capturing information on the PCI devices.

2. The system according to claim 1, wherein the PCI device information identifying module is installed in an Operation System of a computer.

3. A computer-based method for identifying Peripheral Component Interconnect (PCI) device information, the method comprising the steps of:
initializing an address parameter and an address offset to a predetermined first number;
writing a first address value to a configuration port;
reading data from a data port based on the address value;
determining whether there is a corresponding PCI device coupled to a PCI bus based on the data;
adding a predetermined second number to the address parameter if there is no corresponding PCI device coupled to the PCI bus, so as to allocate an address for a next PCI device;
determining whether all the PCI devices have been searched; and
repeating from the second step till all the PCI devices have been searched.

4. The method according to claim 3, further comprising the steps of:
writing a second address value to the configuration port, if there is a corresponding PCI device coupled to the PCI bus;
capturing information on the PCI device from the data port;
adding 1 to the address offset;
determining whether the address offset is less than a predetermined third number, in order to judge whether all information on the PCI device has been captured; and returning to the writing step, if the offset is less than the predetermined third number.

5. The method according to claim 3, further comprising the step of:
capturing information on all the PCI devices, if all PCI devices have been searched.

6. The method according to claim 3, wherein the address of the configuration port is expressed by a predetermined fourth number.

7. The method according to claim 3, wherein the address of the data port is expressed by a predetermined fifth number.

8. The method according to claim 3, wherein the first address value is a sum of the predetermined second number and the address parameter.

9. The method according to claim 3, wherein the step of determining whether there is a corresponding PCI device coupled to the PCI bus is achieved by determining whether the data read from the data port is equal to a predetermined sixth number, and determining there is a corresponding PCI device coupled to the PCI bus if the data is not equal to the predetermined sixth number.

10. The method according to claim 3, wherein the step of determining whether all the PCI devices have been searched is achieved by determining whether the value in the address parameter is more than a predetermined seventh number, and determining all PCI devices have been searched if the value in the address parameter is more than the predetermined seventh number.

11. The method according to claim 3, wherein the predetermined first number is a hexadecimal number “0×00”.

12. The method according to claim 3, wherein the predetermined second number is a hexadecimal number “0×80000000”.

13. The method according to claim 3, wherein the PCI information includes a vendor identification, a device identification, a revision identification, device resources, configuration space and a device status.

14. The method according to claim 4, further comprising the steps of:
resetting the offset to the predetermined first number, if the address offset is more than or equal to the predetermined third number; and
allocating an address for a next PCI device on the PCI bus.

15. The method according to claim 4, wherein the second address value is a sum of the predetermined second number, the address parameter and the address offset.

16. The method according to claim 4, wherein the predetermined third number is a decimal number 64.

17. The method according to claim 6, wherein the predetermined fourth number is a hexadecimal number “0×CF8”.

18. The method according to claim 7, wherein the predetermined fifth number is a hexadecimal number “0×CFC”.

19. The method according to claim 9, wherein the predetermined sixth number is a hexadecimal number “0×FFFFFFF”.

20. The method according to claim 10, wherein the predetermined seventh number is a hexadecimal number “0×80FFFF00”.

21. A computer-based method for identifying Peripheral Component Interconnect (PCI) device information, the method comprising the steps of:
allocating an address on a PCI bus for a PCI device;
searching for a corresponding PCI device coupled to the PCI bus based on the address;
capturing all information on the PCI device;
determining whether all PCI devices have been searched; and
repeating the above steps till all the PCI devices have been searched.
